(19) United States
(12) Patent Application Publication
(10) Pub. No.: US 2014/0360676 A1
(43) Pub. Date: Dec. 11, 2014

(54) TACK ROLL LABEL DISPENSER

(71) Applicant: Keith Muny, Rocky River, OH (US)

(72) Inventor: Keith Muny, Rocky River, OH (US)

(21) Appl. No.: 14/074,994

(22) Filed: Nov. 8, 2013

Related U.S. Application Data
(60) Provisional application No. 61/831,302, filed on Jun. 5, 2013.

(51) Int. Cl. B65C 9/00; B65C 9/30

(52) U.S. Cl. CPC B65C 9/0006; B65C 9/30
USPC 156/577

(57) ABSTRACT

A dispenser for applying labels has a frame having a pair of side walls; an unwind roll mounted to a first end of the frame, the unwind roll has web wound on the unwind roll; A rewind roll is mounted to a second end of the frame; a tack roll is mounted between the unwind roll and the rewind roll for separating a label from a backing material of the web; A plate is positioned relative to the tack roll for separating the label from the backing material for adhering the liner to a sealed package such as a food package. A handle is provided for manually gripping the dispenser.

### CLAIM OF PRIORITY

This application claims priority from Provisional Patent Application Ser. No. 61/831,302, filed on Jun. 5, 2013, the entirety of which is hereby incorporated by reference.

### BACKGROUND OF THE DISCLOSURE

The disclosure relates to label dispensers. More particularly, it relates to a tack roll label dispenser. Specifically, the disclosure relates to a device which mechanizes the removal process of a label from a liner and then laminates it to a surface or object. The device is preferably manually operated and hand held. Alternatively, the device can be mounted to a frame and used as a table top device. Many existing methods of applying adhesive labels onto articles or packages such as sealed food packages or bags involve large and cumbersome machines or processes. It is desirable to provide a reliable, easy-to-use lightweight hand-held label dispenser. Thus, it is desirable to provide a label dispenser which overcomes the above mentioned deficiencies while providing better overall results.

Other aspects of the disclosure will become apparent upon a reading and understanding of the following detailed description.

### BRIEF DESCRIPTION OF THE DISCLOSURE

The purpose of this disclosure is to mechanize the removal process of a sticky label from a roll and laminate it to a surface or object. One aspect of the disclosure is a device which is a simple to operate, low cost mechanism.

In accordance with one aspect of the disclosure, a dispenser for applying labels has a frame having a pair of side walls; an unwind roll mounted to a first end of the frame, the unwind roll has a web wound on the unwind roll; a rewind roll is mounted to a second end of the frame; a tack roll is mounted between the unwind roll and the rewind roll for separating a label from a backing material of the web; a plate is positioned relative to the tack roll for separating the liner from the backing material for adhering the liner to a sealed package; and a handle is provided for manually gripping the dispenser.

Another aspect of the disclosure is a device which standardizes the removal process of taking a label from a liner and adhering it to a surface or object. It specifically allows for the repeated and consistent removal of larger size labels.

Still another aspect of the disclosure is a device which can apply a label to a surface or object where labels are greater than 1 inch (25 mm) in length or width.

Another aspect of the disclosure is a device which dispenses longer, wider, and thinner labels than previously possible with existing devices.

Yet another aspect of the disclosure is a device which is compact, hand-held, lightweight, simple to operate, portable, and ergonomically easy to use. The device is inexpensive which further permits using multiple devices at a low cost in multiple locations.

Another aspect of the disclosure is a device which can alternately be mounted to a frame and used as a table top device.

Still other aspects of the disclosure will become apparent upon a reading and understanding of the following detailed description.

### BRIEF DESCRIPTION OF THE FIGURES

FIGS. 1A, 1B and 1C are side elevational and top plan views of a tack roll label dispenser in accordance with a preferred embodiment of the disclosure;

FIG. 2A is a side elevational view of the tack roll label dispenser in accordance with another aspect of the disclosure;

FIG. 2B is a top plan view of the tack roll label dispenser of FIG. 2A; and

FIG. 3 illustrates a label attached to a shrink wrapped product.

### DETAILED DESCRIPTION OF THE DISCLOSURE

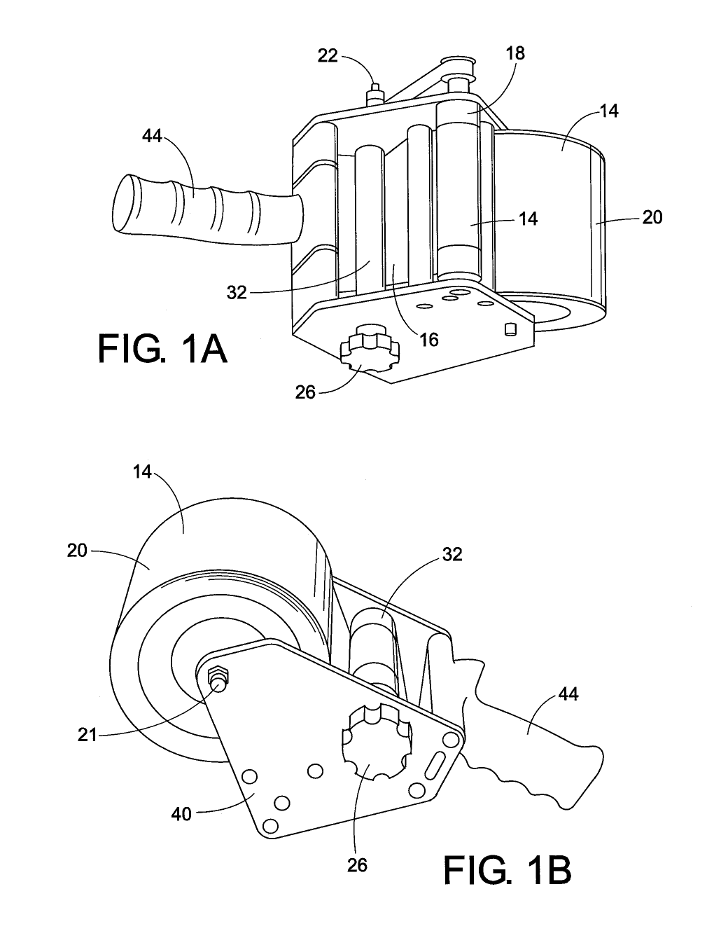

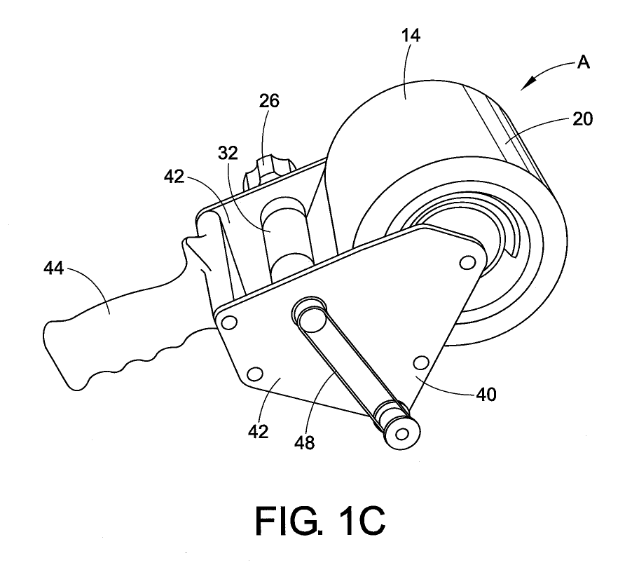

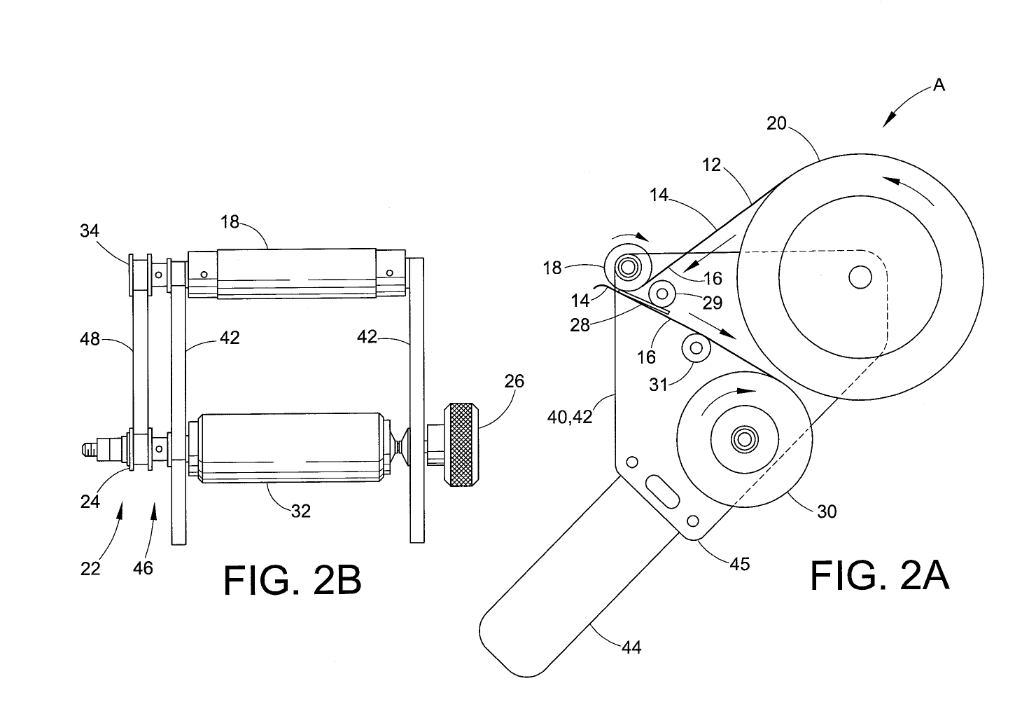

Referring now to FIGS. 1A, 1B, 1C, 2A and 2B, a hand-held tack roll label dispenser A in accordance with the preferred embodiment of the disclosure is shown. Referring to FIG. 2A, the dispenser holds a web 12 of material. A web is a generic term describing a continuous substrate of roll label material. For purposes of this description, the composite roll label material is referred to as the web 12. The composite roll label material is made of two components, the label 14 itself (i.e., the top component or portion of the web) and the liner 16 (i.e., the bottom component or portion of the web 12).

In this device, the liner 16 or the bottom portion of the web is wound up and discarded after use. The liner 16 by definition can also be considered a web 12, but for purposes of this discussion it will be referred to specifically as the liner 16 to distinguish it as a subcomponent substrate of the overall web 12.

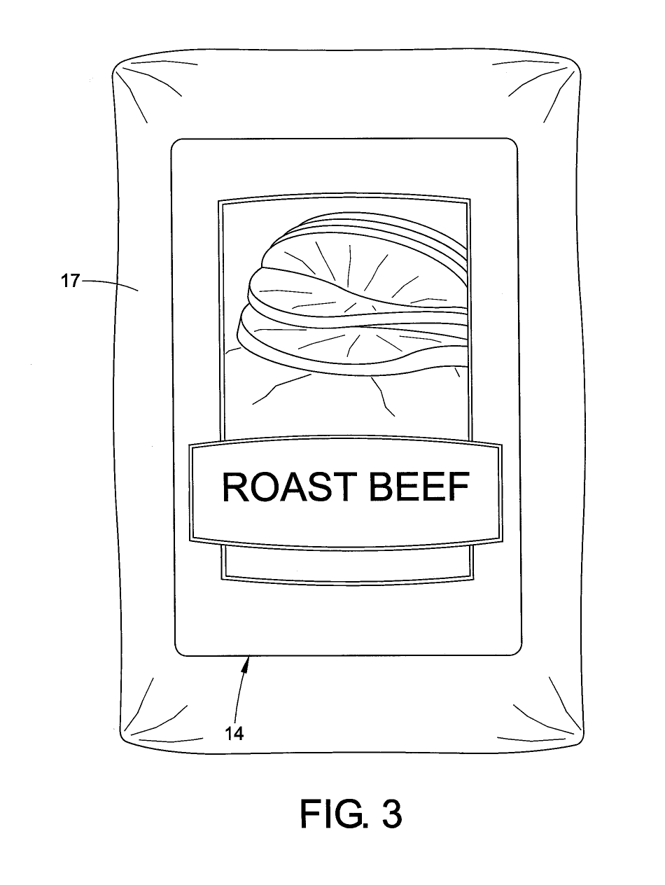

The label 14, i.e., the top component or portion of the web 12, is peeled away and removed from the liner 16 (i.e., the bottom component or a portion of the web) and transferred to a surface or object to be labeled (such as a shrink wrapped or sealed package or container 17 of meat or other food items (FIG. 3) by tack roll 18. The label can be made of various suitable materials such as paper or plastic, but always has some form of adhesive strip or backing to adhere the label to the liner 16. That is, the label 14 backing is designed to specifically adhere to a surface or object to be labeled.

An unwind roll 20 is a large roll mounted at one end 21 of the dispenser and is the section of the device on which the label 14 material is loaded and stored for use. A roll 20 of labels 14 is loaded onto a device which incorporates a tensioning device or assembly 22 (FIG. 2B). As seen in FIG. 2B, the tensioning device 22 includes a rewind gear 24 and a tension knob 26 which adds a drag force to the unwind roll 20 as the web 12 is unwound. That is, the drag force slows down rotation of the roll 20 when the web 12 is pulled and keeps the roll 20 from unwinding too loosely or quickly. It is critical that the unwind roll 20 has some drag force applied to it to enable the device to operate properly. If the unwind roll unwinds too quickly, the device will not properly remove labels and the labels will not separate from the liners.

A tack roll 18 is used to help separate the label from the liner and is preferably covered with a sticky or tacky rubber or elastomeric material coating. The hardness of the rubber preferably has a soft to medium durometer to allow for good lamination. The tack level of the rubber must be greater than the force required to remove the label 14 from the liner 16. The tack roll 18 stays tacky or sticky for a long time, preferably for several years. The tacky rubber functions first to separate and pull the label 14 off of and remove it from the liner 16 and second to allow the label to be applied and laminated to the surface or object and laminate the surface.

A drive gear 34 is directly attached to the shaft of the tack roll 18 and rotates at the same rate as the roll 18. As the tack roll 18 is driven by the user “laminating” the label to the intended surface or object, the drive gear also rotates.

A drive belt 48 in turn connects the drive gear 34 to the rewind gear 24. The drive belt 48 allows the driven torque of the tack roll 18 to translate to rewind shaft 32.

Referring to FIG. 2A, a metal peel plate 28 is oriented at an angle such as 30 or 45 degrees to tack roll 18 and is used to press the label 14 onto the tack roll 18 and also serves as a sharp edge for the liner 16 to engage as the liner 16 is separated from and removed from the web 12. The peel plate 28 removes or peels the liner at nearly a 180 degree angle to the web 12 which facilitates removal of the label 14 from the liner 16. In other words, the peel plate 28 helps force the label 14 to join or adhere to the tack roll 18 and separate the label from the liner 16 as the web 12 moves and travels through the device. Rolls 29, 31 positioned between the tack roll and the rewind roll assist in aligning and moving the liner toward the rewind roll 30.

Referring to FIG. 2A, a rewind roll 30 is the section of the device where scrap liner 16 material is wound up and stored for eventual disposal. That is, liner 16 which has been separated from label 14 is considered scrap liner. This rewind roll section 30 includes a rotating rewind shaft 32 and driven tensioning system 22. The rotating shaft 32 allows the liner 16 material to accumulate as the device is used. The tensioning system 22 includes a clutch 46 and gear 24 which allows the rewind shaft 32 to slip when too much tension is applied to the liner 16. The “scrap” liner 16 continues to accumulate until a maximum or preferred diameter is reached. At that point, the scrap liner 16 is removed and the device is threaded with new material.

The rewind gear 24 is indirectly linked to the rewind shaft 32 by a simple slip clutch 46. The tension knob 26 is directly connected to the rewind shaft 32 and acts as a hand operated means of winding the rewind shaft 32 to take up any slack in the liner 16 as a result of loading or misuse.

A frame 40 of the device includes two side metal plates or side walls 42 and a couple of connecting rods. The frame 40 forms a housing to mount and retain the parts. A handle 44 extends from end 45 of the frame and provides the user an ergonomic means of holding and using the device. The handle 44 allows for easy operation of the overall device.

The following is a description of the operation of the tack roll label dispenser. To load the device for operation, a roll of labels is first loaded onto the unwind or feed section or roll 20 of the device. The web 12 is then threaded through the space or area between the tack roll 18 and the peel plate 28 as shown in FIG. 2A. The label 14 side of the web is positioned directly to touch the tack roll 18. The web 12 then doubles back under the peel plate 28 and liner 16 winds under and over rolls 29, 31 and winds onto the rewind or take up roll 30. Tensions can be adjusted on both the unwind and rewind sections 20, 30 so that the web 12 is tight or taut at both rolls.

To operate the device, a user grips the handle 44 and places or positions the tack roll 18 directly on the work surface such as a shrink wrapped product or sealed food package 17 in a forward position relative to the user. The user than applies a downward force to the device to create a “laminating” pressure. The user then pulls the handle 44 towards the user a proper distance needed to dispense one label 14. As the handle 44 is pulled towards the user, the tack roll 18 rotates and grabs a leading edge of the label 14. The label 14 then transfers to the tack roll 18 since the tack roll 18 has a stronger bond with the label 14 than the bond between the label and the liner 16. The peel plate 28 further enables the label 14 to separate and peel away from the liner 16. The doubling back of the web 12, combined with the tension in the liner 16 as it rewinds, keeps the label 14 from sticking with the liner 16. This process of dispensing labels is easily repeatable and can be performed over and over again until the web 12 is expended.

The drive system assists with the rewinding process. The drive belt 48 links the manually powered tack roll 18 to the rewind shaft 32. The drive system has a 1:1 ratio. The diameter of the tack roll 18 is designed to be smaller than the rewind shaft 32 ensuring that the surface speed of the rewind shaft 32 is greater. This difference in speed results in a tension on the liner 16 as it is rewound due to the faster rewind speed from the rewind shaft 32. If the system were a directly driven system, the liner 16 would become tighter as labels are dispensed. This would result in ultimately breaking the liner 16 or some other component of the system. To prevent this from happening, a clutch 46 is incorporated into the rewind system. The rewind gear 24 is not directly attached to the rewind shaft 32, but is left to run freely. An adjustable spring device is designed into the rewind gear assembly. This adjustable spring adds side pressure onto the rewind gear allowing it to turn the rewind shaft 32. As the tension in the liner 16 gets tighter, this liner 16 tension exceeds the side pressure setting and the rewind gear slips on the rewind shaft 32 so as not to break the liner 16 or device.

The unwind roll or section 20 is configured to easily load a roll of labels and adjust the unwind tension. One end of the unwind section 20 is fixed and the other end is open. This is known as an open end cantilever design. The rewind roll or section 30 is also designed with an open end cantilever system. The cantilever design makes for easy access to the user. It also reduces the weight and size of the overall design to make the device even more ergonomic and easy to hold and use.

The device has been described with reference to the preferred embodiment which is a manually used hand-held device.

In accordance with another embodiment of the disclosure, the device can be mounted onto a frame and used as a table top device. The components of the device would be substantially as described above for the hand-held device except instead of a handle 44, the device would be mounted to a frame and operated as a table top device. The size of the labels can be greater in length and width than those used with the hand-held device, such as twice the width or length.

The exemplary embodiment has been described with reference to the preferred embodiments. Obviously, modifications and alterations will occur to others upon reading and understanding the preceding detailed description. It is intended that the exemplary embodiment and the appended claims be construed as including all such modifications and alterations insofar as they come within the scope of the exemplary embodiment.

1. A dispenser for applying labels to a sealed package comprising:
a frame comprising a pair of side walls;
an unwind roll mounted to a first end of said frame, said unwind roll comprises a web wound on said unwind roll;
a rewind roll mounted to a second end of said frame;
a tack roll mounted between said unwind roll and said rewind roll for separating a label of said web from a backing material of said web;
a plate positioned relative to said tack roll for separating said liner from said backing material for adhering said liner to said sealed package; and
a handle for manually gripping said dispenser.

2. The dispenser of claim 1, wherein said unwind roll comprises a roll of labels.

3. The dispenser of claim 1, further comprising a tensioning assembly mounted to said rewind roll.

4. The dispenser of claim 3, wherein said tensioner assembly comprises a rewind gear and a tension knob to add a drag force to said unwind roll as said web is unwound.

5. The dispenser of claim 1, wherein said tack roll comprises an elastomeric material coating.

6. The dispenser of claim 1 further comprising a drive gear attached to said tack roll for rotating with said tack roll.

7. The dispenser of claim 6, further comprising a drive belt attaching said drive gear to said rewind gear.

8. The dispenser of claim 1, wherein said plate is oriented at an angle in the range of 30 to 45 degrees with respect to said tack roll.

9. The dispenser of claim 8, wherein said plate is fabricated from metal.

10. The dispenser of claim 1, further comprising a pair of rolls positioned between said tack roll and said rewind roll for dispensing and guiding said backing material toward said rewind roll.

11. The dispenser of claim 3, wherein said tensioning assembly further comprises slip clutch and gear to allow and rewind roll to slip when tension is applied to said liner.

12. The dispenser of claim 8, wherein said plate separates said label from said backing material and said label is rolled onto said sealed package.
